(19) United States
(12) Patent Application Publication
(10) Pub. No.: US 2009/0028666 A1
(43) Pub. Date: Jan. 29, 2009

(54) Nut for Reinforcing Bar

(75) Inventor: Mituo Nakamura, Fukuoka (JP)

Correspondence Address: FITCH, EVEN, TABIN & FLANNERY, P. O. BOX 18415, WASHINGTON, DC, 20036, US

(73) Assignees: Tama Home Co., Ltd, Tokyo (JP); Mituo Nakamura, Fukuoka (JP)

(21) Appl. No.: 12/086,980

(22) PCT Filed: Oct. 30, 2006
(86) PCT No.: PCT/JP2006/321649

§ 371 Date: Jun. 23, 2008

(30) Foreign Application Priority Data
Dec. 22, 2005 (JP) 2005 370826

(51) Int. Cl. F16B 37/00

(52) U.S. Cl. 411/427

(57) ABSTRACT

A nut for a reinforcing bar capable of stably maintaining its screwed state with a reinforcing bar and enabling the reduction of its projecting portion from the end face of a structural body. The nut for a reinforcing bar (10) comprises a cylindrical body part (10a), a regular hexagonal flange (10b) formed at one end of the body part (10a), and a female screw thread part formed on the inner peripheral surface of the flange (10b). The body part (10a) is insertable into a through hole formed in a concrete block, and the female screw thread part formed on the inner peripheral surface of the body part (10a) can be screwed onto a male screw part formed on the outer periphery of the reinforcing bar inserted into the through hole. Three pairs of flat parts (10d) parallel with each other with respect to the center axis (X) of the body part (10a) are formed on the outer periphery of the regular hexagonal flange (10b). The length of the female screw thread part on the inner peripheral surface of the body part (10a) in the direction of the center axis X is approximately four times the screw pitch of the male screw part on the outer periphery of the reinforcing bar.

### FIELD OF THE INVENTION

The present invention relates to a nut for a reinforcing bar used for fixing a reinforcing bar which is a structural member of a concrete block structure and for applying a tensile force to a reinforcing bar.

### BACKGROUND ART

When a structural body such as a wall is built by joining a plurality of concrete blocks in horizontal and vertical directions, a reinforcing bar is often inserted into the concrete blocks stacked in a vertical direction in order to secure the strength of the structural body. In such a case, the stacked concrete blocks are firmly attached so as to further increase the strength. For this purpose, a technique has been proposed for fastening blocks using a nut which is screwed onto an end portion of a reinforcing bar sticking out from an end face of the block (see Patent Document 1, for example).

In a construction method of a bearing wall described in Patent Document 1, a reinforcing bar (bolt) is inserted into a vertical hole at the center of each of a plurality of blocks which are vertically arranged in a row with a paste interposed between the blocks, and nuts are screwed on both ends of the reinforcing bar, thereby building a wall structure composed of a group of blocks vertically arranged in a row.

Patent Document 1: Japanese Patent Publication No. S34-03622

### DISCLOSURE OF THE INVENTION

### Problems to be Solved by the Invention

In the construction method of a bearing wall described in Patent Document 1, the nuts are screwed onto both ends of the reinforcing bar (bolt) which constitutes a wall structure composed of a group of blocks vertically arranged in a row. In order to prevent the nuts from loosening or falling out after building the wall, the area of screwing the nut onto the bolt should be kept wider in the axial direction, or the end portion of the bolt projecting from the end face of the tightened nut should be long. Thus, the bolt and the nut project from both end faces of the group of blocks to a considerable amount, which sometimes hinders the work of construction.

An object of the present invention is to provide a nut for a reinforcing bar capable of stably maintaining its securely screwed state with a reinforcing bar and enabling the reduction of its projecting portion from the end face of a structural body.

### Means for Solving the Problems

A nut for a reinforcing bar of the present invention comprises a cylindrical body part which is insertable into a through hole formed in a concrete block and includes a female screw thread part formed on an inner peripheral surface of the body part, the female screw thread part capable of being screwed onto a male screw part formed on an outer periphery of a reinforcing bar which is inserted into the through hole, and a flange which is formed at one end of the body part. In this structure, on an end portion of a reinforcing bar inserted into a through hole of a concrete block (referred to as “block” hereinafter) and projecting from an end face thereof, a member having a function of a washer is mounted. Then, the nut for a reinforcing bar is screwed onto the reinforcing bar with its flange facing outside so that the reinforcing bar is fixed in the block and a tensile force is applied to the reinforcing bar, thereby building a structural body. In this state, the body part which is screwed onto the male screw part is insertable into the through hole of the block. Accordingly, the projecting portion of the nut for a reinforcing bar sticking out from the end face of the structural body can be reduced. Moreover, the length of the body part inserted into the through hole of the block in the direction of its center axis can be optionally set according to required tightening strength. Therefore, the screwed state with the reinforcing bar can be held stably.

Here, preferably, at least a pair of flat parts parallel with each other with respect to the center axis of the body part may be formed on the outer periphery of the flange. By this structure, a tool such as a wrench can be engaged with the pair of flat parts on the outer periphery of the flange, which enhances operability for tightening.

In addition, the length of the female screw thread part of the body part in the direction of the center axis of the female screw thread part may be three to four times the screw pitch of the male screw part on the outer periphery of the reinforcing bar. Thus, while the length of the body part in the direction of the center axis is controlled to the minimum, the tightening strength applied to the reinforcing bar can be secured.

### EFFECTS OF THE INVENTION

With the nut for a reinforcing bar of the present invention, the screwed state with the reinforcing bar can be maintained stably, and the portion projecting from the end face of a structural body can be reduced.

### BRIEF DESCRIPTION OF THE DRAWINGS

FIG. 1A is a front view which illustrates a nut for a reinforcing bar of an embodiment of the present invention;

FIG. 1B is a side view of the nut for a reinforcing bar of FIG. 1A;

FIG. 2 is a sectional view taken along the line A-A in FIG. 1A;

FIG. 3A is a plan view of a concrete block;

FIG. 3B is a front view of the concrete block of FIG. 3A;

FIG. 3C is a side view of the concrete block of FIG. 3B;

FIG. 4 is a perspective view which illustrates the nut for a reinforcing bar shown in FIGS. 1A and 1B and a flat structural body formed with the concrete blocks shown in FIGS. 3A, 3B and 3C and other members;

FIG. 5 is a sectional view taken along the line B-B in FIG. 4;

FIG. 6 is a partial enlarged view of FIG. 5;

FIG. 7 is a sectional view taken along the line C-C in FIG. 4; and

FIG. 8 is a partial enlarged view of FIG. 7.

### DESCRIPTION OF REFERENCE NUMERALS AND SYMBOLS

10: nut for a reinforcing bar
10a: body part
10b: flange
10c: female screw thread part
10d: flat part
10x: length in a direction of a center axis
11, 11x: block
11a: upper face
11b: lower face
11c: left side face
11d: right side face
11e: back face
11f: front face
12, 19a, 20a: through hole
13: concave part
14, 15: reinforcing bar
14a, 15a: male screw part
16: hollow part
17, 21: rectangular groove
18: oval groove
19, 20: holding plate
22: flat structural body
S: cement paste
T: tensile force
X: center axis

### BEST MODE FOR CARRYING OUT THE INVENTION

An embodiment of the present invention is explained below with reference to the drawings.

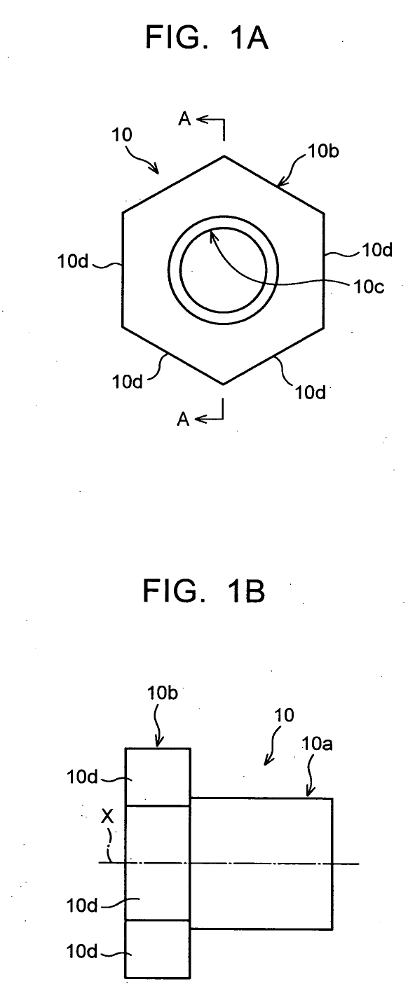

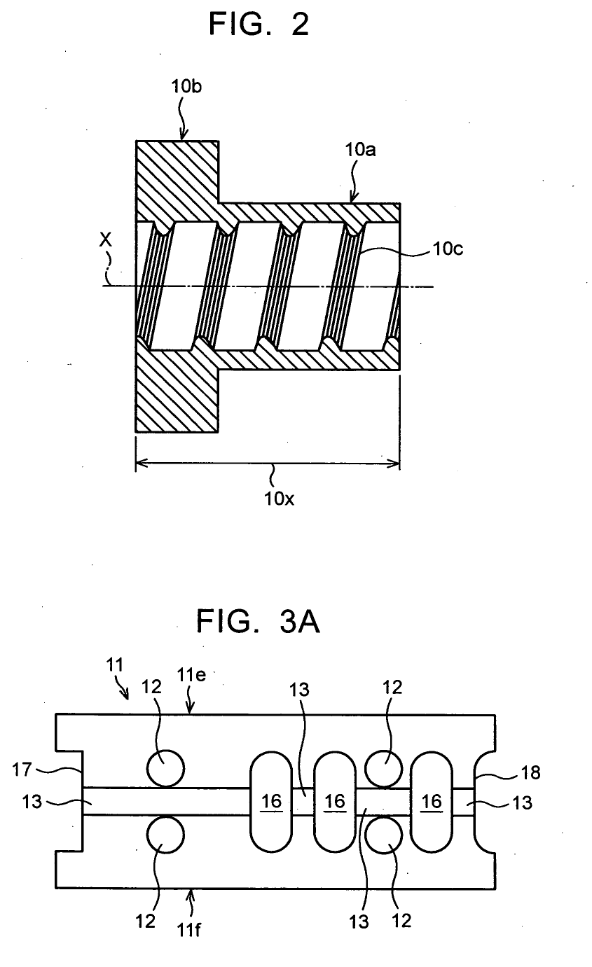

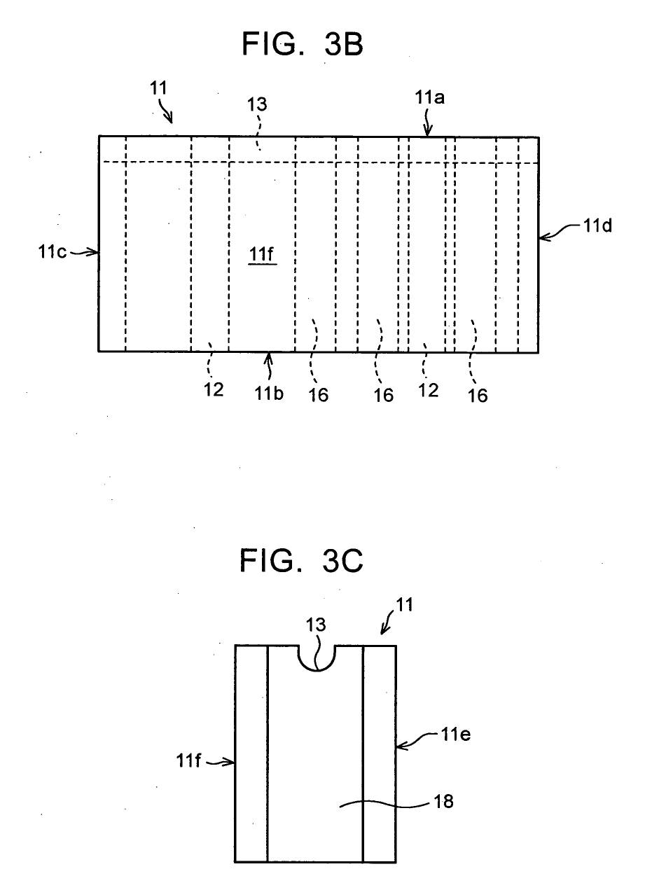

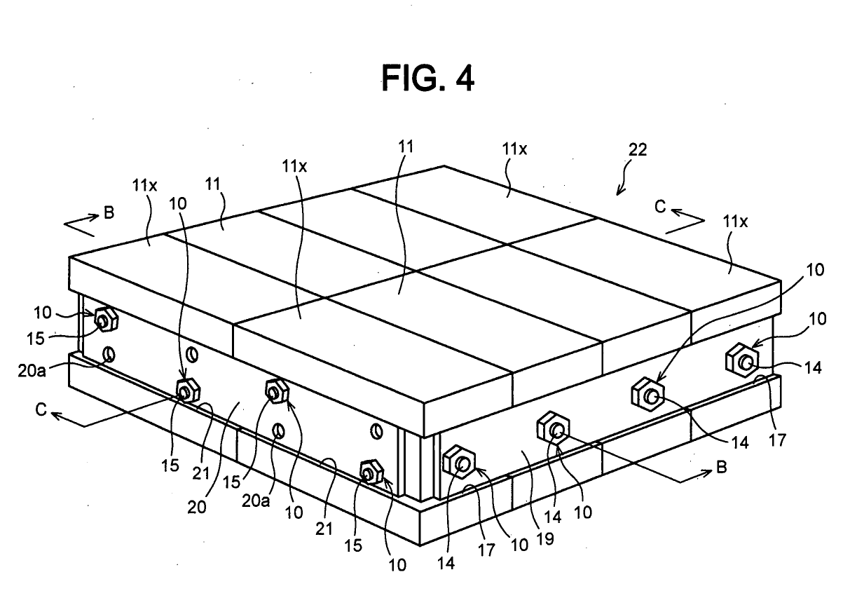

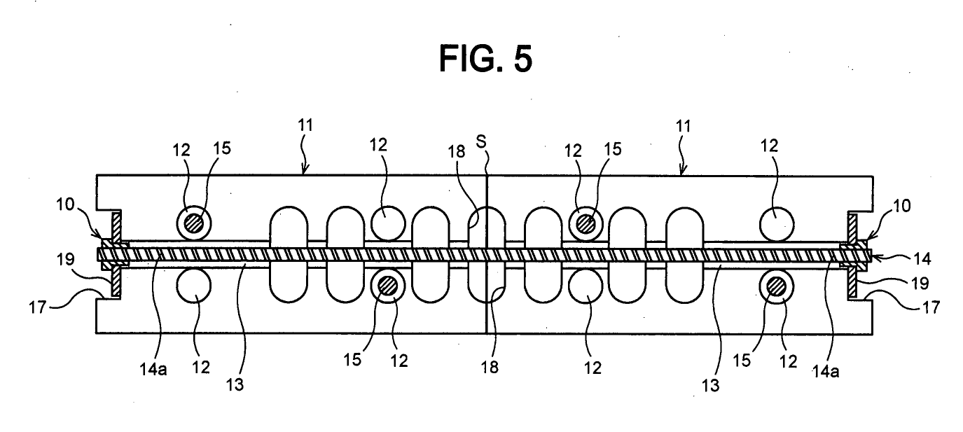

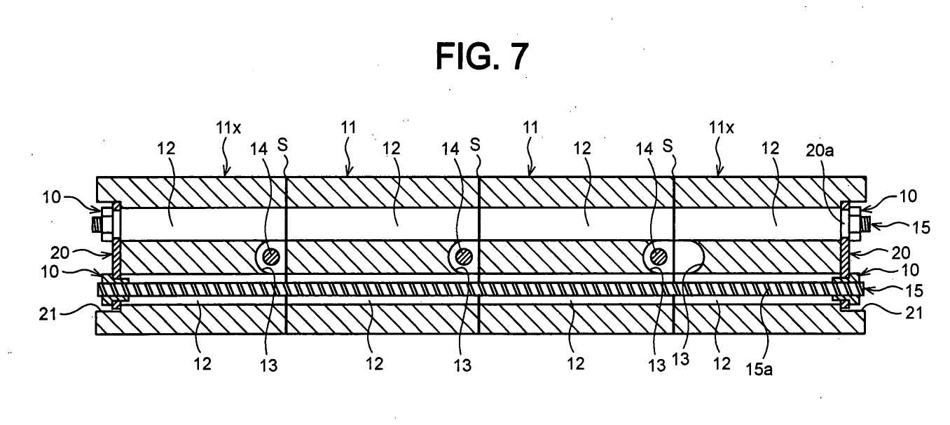

As shown in FIGS. 1A, 1B and 2, a nut for a reinforcing bar 10 of the present embodiment includes a cylindrical body part 10a, a regular hexagonal flange 10b formed at one end of the body part 10a, and a female screw thread part 10c formed on an inner peripheral surface of the flange 10b. As shown in FIGS. 3A, 3B, 3C and 4, the body part 10a is insertable into a through hole 12 and a concave part 13 which are formed in a concrete block 11. The female screw thread part 10c formed on the inner peripheral surface of the body part 10a is engageable with male screw parts 14a and 15a formed on an outer periphery of reinforcing bars 14 and 15 inserted into the through hole 12 and the concave part 13 (see FIGS. 5 and 7).

On an outer periphery of the regular hexagonal flange 10b, three pairs of flat parts 10d are formed in parallel with each other with respect to a center axis X of the body part 10a. On the inner peripheral surface of the body part 10a, a length 10x of the female screw thread part 10c in a direction of the center axis X is approximately four times a screw pitch of the male screw parts 14a and 15a on the outer periphery of the reinforcing bars 14 and 15.

Here, a use of the nut for a reinforcing bar 10 is explained below with reference to FIGS. 3A, 3B, 3C, 4 and 5 to 8.

As shown in FIGS. 3A, 3B and 3C, a plurality of blocks 11 are flatly arranged with four outer peripheral surfaces of each block attached to each other. The four surfaces are an upper face 11a, a lower face 11b, a left side face 11c, and a right side face 11d. The blocks 11 are joined to each other by a process described after to form a flat structural body 22 shown in FIG. 4. A plurality of through holes 12 into which the reinforcing bars 15 are insertable are formed in each of the blocks II in parallel with a front face 11f and a back face 11e of the block 11. The concave part 13 for receiving the reinforcing bar 14 thereon is formed on the upper face 11a running in a crossing direction above the reinforcing bars 15 inserted into the through holes 12. The block II further includes a plurality of hollow parts 16 formed so as to penetrate from the upper face 11a to the lower face 11b. A rectangular groove 17 and an oval groove 18 are formed on the left side face 11c and the right side face 11d, respectively, in the same direction with the hollow parts 16.

As shown in FIG. 4, the plurality of blocks 11 are flatly arranged with the outer peripheral surfaces of each block attached to each other so that the plurality of through holes 12 and the hollow parts 16 communicate with each other, respectively, to form a straight line in a direction of the respective center axis of the through hole 12 and the hollow part 16. In this case, a cement paste S is interposed between the adjacent blocks 11. The reinforcing bar 15 is inserted into the plurality of through holes 12 communicating with each other while the reinforcing bar 14 is inserted into the plurality of concave parts 13 communicating with each other in the crossing direction above the through holes 12. Then, as shown in FIG. 5, a holding plate 19 which has a function of a washer is placed on the plurality of rectangular grooves 17 arranged in a row, and the nut for a reinforcing bar 10 is screwed onto the reinforcing bar 14 projecting from a through hole 19a which is opened in the holding plate 19.

On the other hand, as shown in FIG. 7, a holding plate 20 which has a function of a washer is placed on an end face of a block 11x positioned at both ends of the structural body, and the nut for a reinforcing bar 10 is screwed onto the reinforcing bar 15 projecting from a through hole 20a which is opened in the holding plate 20. In this case, internal diameters of the through holes 19a and 20a in the holding plates 19 and 20 are larger than an external diameter of the body part 10a of the nut for a reinforcing bar 10. Therefore, the body part 10a of the nut for a reinforcing bar 10 can be inserted into the through holes 19a and 20a with the flange 10b facing outside. Here, on the end face of the block 11x positioned on both side of the structural body, a rectangular groove 21 is formed to receive the holding plate 20.

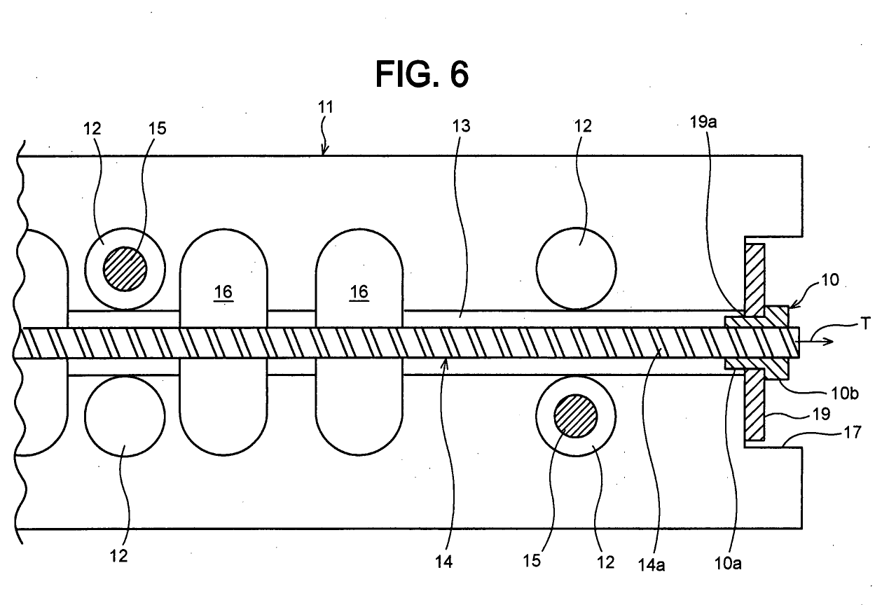

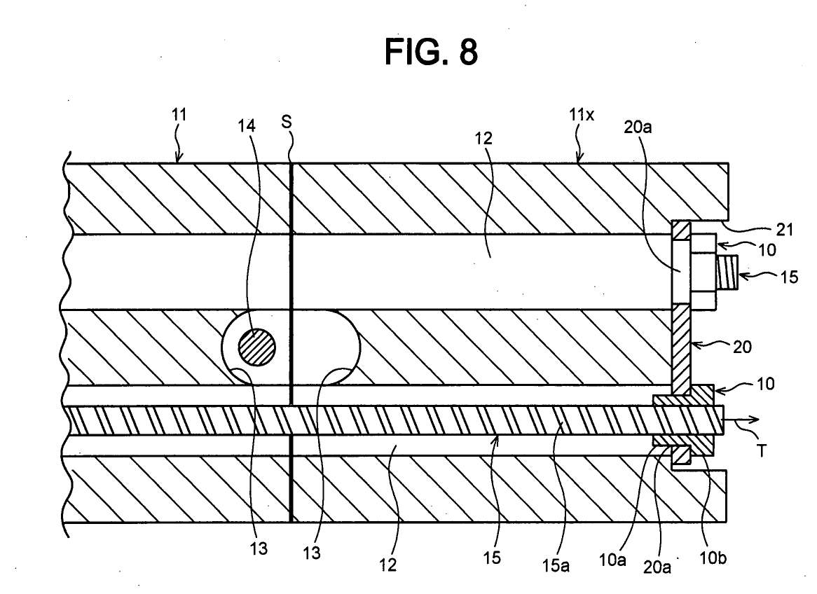

Then, each of the nuts for a reinforcing bar 10 screwed on the reinforcing bars 14 and 15 is tightened to apply a tensile force to the reinforcing bars 14 and 15, thereby firmly clamping the plurality of blocks 11 and 11x lengthwise and crosswise. Thus, when the cement paste S is hardened after some time, the flat structural body 22 in an integrally formed state is provided. In the present embodiment, a tensile force is applied to the reinforcing bars 14 and 15 by tightening the nut for a reinforcing bar 10. However, the method is not limited to this, and it is also possible to tighten the nut for a reinforcing bar 10 while applying a tensile force T to the reinforcing bars 14 and 15 using a fluid pressure jack, for example (see FIGS. 6 and 8), and then to release the tensile force T thereafter.

In the nut for a reinforcing bar 10, the body part 10a which is screwed onto the male screw parts 14a and 15a of the reinforcing bars 14 and 15 can penetrates the through holes 19a and 20a of the holding plates 19 and 20 and be inserted into the through hole 12 and the concave part 13 of the blocks 11 and 11x. Accordingly, the projecting portion of the nut for a reinforcing bar 10 sticking out from the end face of the blocks 11 and 11x positioned on the outer peripheral part of the flat structural body 22 can be reduced. Moreover, the length 10x of the body part 10a inserted into the through hole 12 and the concave portion 13 of the blocks 11 and 11x in the direction of the center axis X can be optionally set according to the required tightening strength. Therefore, by setting the length 10x to be suitable for each constructing condition, the screwed state with the reinforcing bars 14 and 15 can be stably maintained over a long period of time after the flat structural body 22 has been built.

In the present embodiment, when the length 10x of the body part 10a in the direction of the center axis X was made to be approximately four times the screw pitch of the male screw parts 14a and 15a on the outer periphery of the reinforcing bars 14 and 15, sufficient tightening strength applied to the reinforcing bars 14 and 15 was secured while the length 10x was controlled to the minimum.

In the meantime, since the outer periphery of the flange 10b of the nut for a reinforcing bar 10 has a regular hexagonal shape, a tool such as a wrench can be engaged with the pair of flat parts 10d on the outer periphery of the flange 10b for tightening the nut for a reinforcing bar 10, which enhances operability. If, however, it is intended to prevent the nut for a reinforcing bar 10 constituting the flat structural body 22 from being loosened by vandalism or stolen, it is possible to form the flange 10b in a round shape or in a shape that is not engageable with a common tool such as a wrench.

The above-described embodiment shows one example of using the nut for a reinforcing bar 10. The nut for a reinforcing bar of the present invention is not limited to this embodiment and can be widely used also in other fields than the use as a member constituting the flat structural body 22, which exhibits the same effects and advantages as in the above-described embodiment.

### INDUSTRIAL APPLICABILITY

The nut for a reinforcing bar according to the present invention can be widely used in such an industrial field where a reinforcing bar as a member constituting a concrete block structure is fixed or a tensile force is applied to a reinforcing bar.

1. A nut for a reinforcing bar comprising:
a cylindrical body part which is insertable into a through hole formed in a concrete block and includes a female screw thread part formed on an inner peripheral surface of the body part, the female screw thread part capable of being screwed onto a male screw part formed on an outer periphery of a reinforcing bar which is inserted into the through hole, and
a flange which is formed at one end of the body part.

2. The nut for a reinforcing bar according to claim 1, wherein at least a pair of flat parts parallel with each other with respect to a center axis of the body part is formed on an outer periphery of the flange.

3. The nut for a reinforcing bar according to claim 1, wherein a length of the female screw thread part of the body part in a direction of a center axis of the female screw thread part is from three to four times a screw pitch of the male screw part on the outer periphery of the reinforcing bar.
